(19) United States
(12) Patent Application Publication
(10) Pub. No.: US 2022/0236969 A1
(43) Pub. Date: Jul. 28, 2022

(54) NON-TRANSITORY COMPUTER-READABLE MEDIUM AND CLASS GENERATION METHOD

(71) Applicant: FUJITSU LIMITED, Kawasaki-shi (JP)

(72) Inventors: Koji Kurihara, Kawasaki (JP); Kentaro Kawakami, Kawasaki (JP); Moriyuki Saito, Sagamihara (JP)

(73) Assignee: FUJITSU LIMITED, Kawasaki-shi (JP)

(21) Appl. No.: 17/723,516

(22) Filed: Apr. 19, 2022

Related U.S. Application Data
(63) Continuation of application No. PCT/JP2019/046992, filed on Dec. 2, 2019.

(51) Int. Cl. G06F 8/41

(52) U.S. Cl. CPC G06F 8/41

(57) ABSTRACT

This disclosure relates to a non-transitory computer-readable recording medium storing a class generation program that causes a computer to execute a process. The process includes a step S13 that acquires a first class, a second class, and a lexical token which are associated with each other by referring to a storage unit 53 that stores the first class, the second class, and the lexical token in association with each other, the first class representing a first format about a vector register vn, the second class representing a second format about the vector register vn and inheriting the first class; and a step S15 that generates any one of a first code 77 that generates an instance of the acquired second class and a second code 78 that overloads the acquired lexical token, inside the acquired first class depending on the acquired lexical token.

### CROSS-REFERENCE TO RELATED APPLICATION

This application is based upon and claims the benefit of priority of the prior International Patent Application No. PCT/JP2019/046992, filed on Dec. 2, 2019, the entire contents of which are incorporated herein by reference.

### FIELD

A certain aspect of the embodiments is related to a non-transitory computer-readable medium and a class generation method.

### BACKGROUND

A JIT (Just In Time) compiler technology is one of the technologies to increase the execution speed of programs. The JIT compiler technology is a technology in which a developer writes in a source code a function that executes the same process as an instruction included in an instruction set of a processor, and then includes the machine language of the instruction in the compiled executable program. Thereby, the machine language suitable for high-speed processing the input parameters during program execution can be included in the executable program, and the execution speed of the program can be increased.

In such JIT compiler technology, it would be convenient for the developer if arguments of the function that perform the same processing as the instruction as described above could be described in a syntax similar to the assembly syntax familiar to the developer. However, since the respective syntaxes of the languages used in the source code and the assembly are different from each other, it is difficult to describe the arguments of the function in this assembly-like syntax. Note that the technique related to the present disclosure is disclosed in Japanese Laid-Open Patent Publication No. 2012-256150.

### SUMMARY

In one aspect of embodiments, there is provided a class generation program that causes a computer to execute a process. The process includes acquiring a first class, a second class, and a lexical token which are associated with each other by referring to a storage unit that stores the first class, the second class, and the lexical token in association with each other, the first class representing a first format about a vector register, the second class representing a second format about the vector register and inheriting the first class, and generating any one of a first code that generates an instance of the acquired second class and a second code that overloads the acquired lexical token, inside the acquired first class depending on the acquired lexical token.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of a C++ pseudo source code that is premised to be compiled with an AOT compiler technology;

FIG. 1B is a diagram illustrating an example of a C++ pseudo source code in which a parameter “q” and arrays “in” and “out” are declared;

FIG. 1C is a diagram illustrating an example of a C++ pseudo source code in which initial values of an array “Tbl” are declared;

FIG. 2 is a schematic diagram illustrating a pseudo code of the assembly obtained by compiling a source code with the AOT compiler technology;

FIG. 3 is a diagram schematically illustrating the operation of an executable program obtained by the AOT compiler technology;

FIG. 4 is a diagram illustrating an example of an C++ pseudo source code that is premised to be compiled with a JIT compiler technology;

FIG. 5 is a schematic diagram illustrating a pseudo code of the assembly obtained by compiling the source code of FIG. 4 with the JIT compiler technology when the input parameter “q” is “8”;

FIG. 6 is a schematic diagram illustrating the operation of an executable program composed of a machine language obtained by compiling the source code with JIT compiler technology;

FIG. 7 is a hardware configuration diagram illustrating a target machine capable of executing a SIMD instruction;

FIG. 8A is a schematic diagram illustrating a format for specifying a 128-bit length vector register vn in AArch64;

FIG. 8B is a schematic diagram illustrating a format for specifying a 64-bit length vector register vn in AArch64;

FIG. 9 is a diagram summarizing the size of the element and the number of elements for each of formats;

FIG. 10 is a schematic diagram illustrating a method of writing an assembly using the formats of FIGS. 8A and 8B;

FIG. 11 is a diagram illustrating an example of a C++ pseudo source code of a mnemonic function mul corresponding to a mul instruction;

FIG. 12 is a diagram illustrating a pseudo source code of a C++ class definition previously written by a developer to allow him to write the arguments of the mnemonic function in an assembly-like syntax;

FIG. 13 is a diagram illustrating a description example of the arguments of the mnemonic function mul;

FIG. 14 is a schematic diagram of a C++ pseudo source code for explaining a problem;

FIG. 15 is a schematic diagram illustrating the operation of an information processing apparatus according to the present embodiment (part 1);

FIG. 16 is a schematic diagram illustrating a C++ pseudo source code described in a target description file in the present embodiment;

FIG. 17 is a schematic diagram illustrating a C++ pseudo source code described in a header file in the present embodiment;

FIG. 18 is a schematic diagram illustrating the operation of the information processing apparatus according to the present embodiment (part 2);

FIG. 19 is a schematic diagram illustrating a C++ pseudo source code of the header file generated by a class generation unit according to the present embodiment (part 1);

FIG. 20 is a schematic diagram illustrating the C++ pseudo source code of the header file generated by the class generation unit according to the present embodiment (part 2);

FIG. 21 is a schematic diagram illustrating a development environment according to the present embodiment;

FIG. 22 is a diagram illustrating a description example of the mnemonic function mul in the source file of the present embodiment.

FIG. 23 is a schematic diagram illustrating a C++ pseudo source code for explaining an advantage obtained in the present embodiment;

FIG. 24 is a functional configuration diagram illustrating the information processing apparatus according to the present embodiment;

FIG. 25 is a flowchart illustrating a class generation method according to the present embodiment; and

FIG. 26 is a hardware configuration diagram illustrating the information processing apparatus according to the present embodiment.

### DESCRIPTION OF EMBODIMENTS

In an aspect of embodiments, the purpose of the present disclosure is to enable the use of the assembly-like syntax in the source code.

Prior to the description of the present embodiment, matters studied by an inventor will be described.

As mentioned above, the JIT compiler technology is useful for increasing the execution speed of a program. The advantages of such JIT compiler technology will be explained in comparison with the AOT (Ahead Of Time) compiler technology.

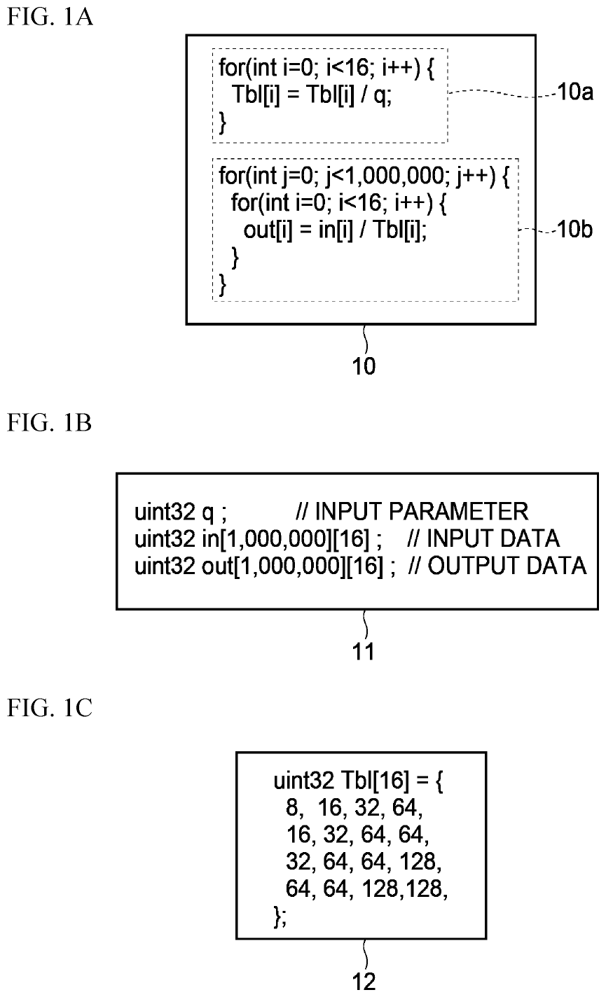

FIG. 1A is a diagram illustrating an example of a C++ pseudo source code 10 that is premised to be compiled with the AOT compiler technology.

In the AOT compiler technology, a developer writes a source code according to the syntax of C or C++, and a compiler such as GCC (GNU Compiler Collection) compiles the source code into a machine language.

In an example in FIG. 1A, each element of an array “Tbl” is divided by a parameter “q” in process 10a. Then, in process 10b, an element of the array “in” is divided by the element of the array “Tbl” and its result is stored in an array “out”.

FIG. 1B is a diagram illustrating an example of a C++ pseudo source code 11 in which the above-mentioned parameter “q” and the above-mentioned arrays “in” and “out” are declared.

The parameter “q” is a divisor in the process 10a described above, and hereinafter is also referred to as an input parameter. The arrays “in” and “out” are input data and output data in process 10b, respectively. The data to be stored in these arrays “in” and “out” is not particularly limited. Here, the array “in” and the array “out” are declared as two-dimensional arrays that store 1000000 images each of which includes 16 pixel data.

FIG. 1C is a diagram illustrating an example of a C++ pseudo source code 12 in which initial values of the array “Tbl” are declared.

The array “Tbl” is an array that stores the values of a quantization table that quantizes the pixel data. Here, the array “Tbl” is declared as an array having 16 elements corresponding to each of the arrays “in” and “out”. The initial value of each element of the array “Tbl” is a power of 2.

All the source codes 10 to 12 are written by the developer in accordance with the syntax of C or C++, and are converted into assemblies by the compiler.

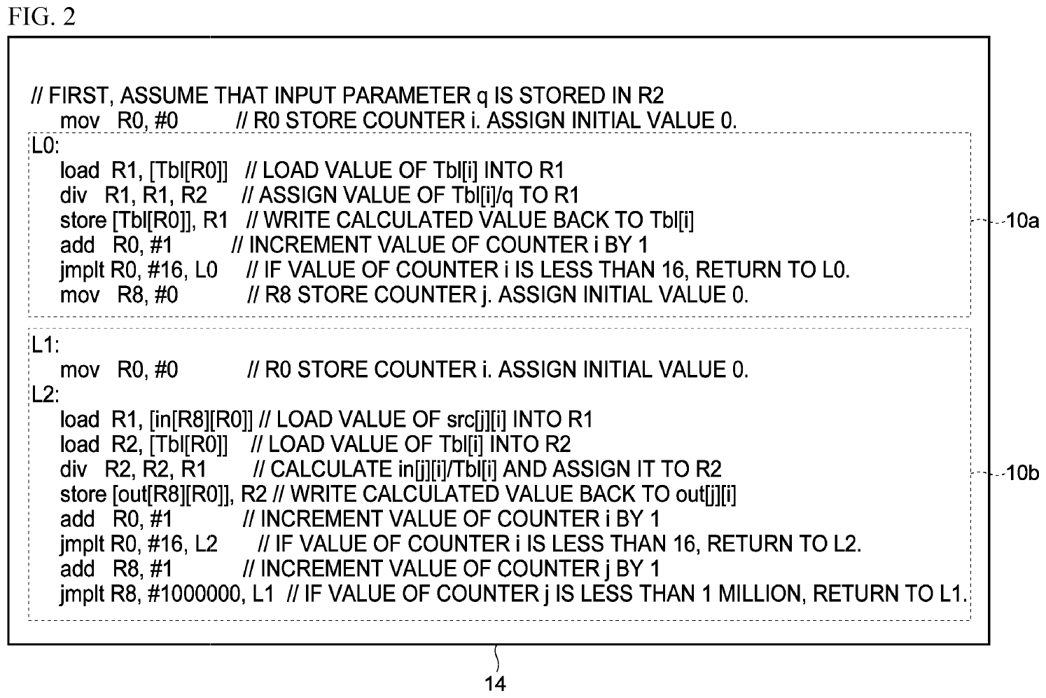

FIG. 2 is a schematic diagram illustrating a pseudo code of an assembly 14 obtained by compiling the source code 10 with the AOT compiler technology.

In the assembly 14, a plurality of instructions included in an instruction set of a target machine are described depending on each of the processes 10a and 10b in the source code 10. Hereinafter, a case where the instruction set is AArch64 of ARM Ltd. will be described as an example.

For example, the process 10a is realized by six instructions from a load instruction to a mov instruction, and the process 10b is realized by nine instructions from the mov instruction to a jmplt instruction. These instructions perform various operations on the registers and immediate values described as operands. Here, general-purpose registers are represented by Rn (n=0, 1, 2, . . . ), and labels representing instruction locations are represented by Lm (m=0, 1, 2, . . . ). Then, it is assumed that the input parameter “q” is initially stored in the register R2.

In addition, all instructions included in the instruction set are uniquely identified by names called mnemonic. For example, the mnemonic for the mov instruction is “mov” and the mnemonic for the store instruction is “store”.

In assembly 14, the syntax of describing operands after the mnemonic of the instruction is adopted. For example, “mov R0, #0” is an instruction to store an immediate value “0” in a register R0. Also, “load R1, [Tbl[R0]]” is an instruction to load the contents of the memory at an address Tbl[R0] into a register R1.

On the other hand, “store [Tbl[R0]], R1” is an instruction to store the contents of the register R1 to the memory address Tbl[R0]. Also, “div R1, R1, R2” is an instruction to store a value obtained by dividing the contents of the register R1 by the contents of the register R2 in the register R1. Then, “jmplt R0, #16, L0” is an instruction to jump to a label L0 when the content of the register R0 is less than an immediate value “16”.

Here, consider the instruction “div R2, R2, R1” in the process 10b. This instruction is an instruction corresponding to “in[i]/Tbl[i]” in the process 10b of the source code 10. The divisor Tbl[i] is divided by the input parameter “q” in process 10a of source code 10, but the above instruction “div R2, R2, R1” is an instruction that gives a correct result of division regardless of the value of the input parameter “q”. Therefore, the assembly 14 is a generic code that gives the correct result for any input parameter “q”.

However, the div instruction has a larger number of execution cycles than other instructions, resulting in a decrease in throughput. Depending on the instruction set, the number of execution cycles for instructions other than the div instructions is 1 to 5, while the number of execution cycles for the div instruction is about 80. Furthermore, in deep learning, image processing, or the like, the number of loops in the for loop is huge, and the div instruction inside the for loop makes the throughput decrease even more pronounced.

The assembler translates such an assembly 14 into the machine language, which results in the executable program composed of the machine language.

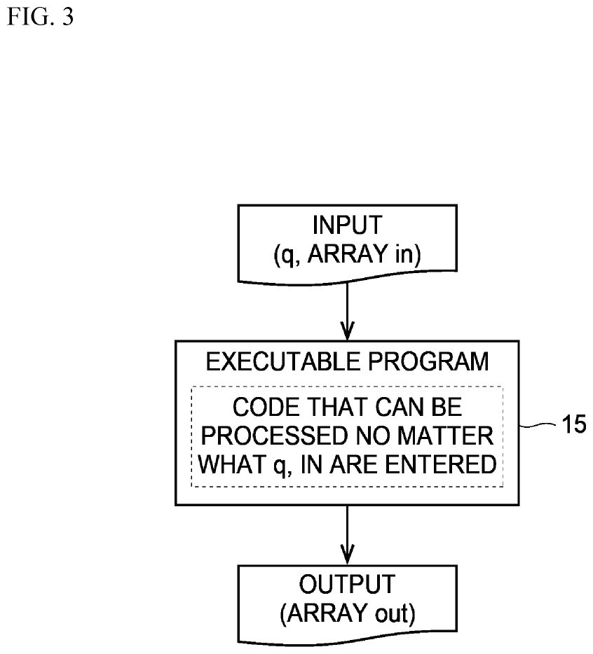

FIG. 3 is a diagram schematically illustrating the operation of the executable program obtained by the AOT compiler technology.

As illustrated in FIG. 3, the executable program 15 accepts the input of each element of the array “in” which is the input data, and the input parameter “q”. Then, as described above, regardless of the values of the input parameter “q” and the array “in”, the executable program performs the same process and stores the result of the process in each element of the array “out”.

Next, a program premising the JIT compiler technology that can suppress the decrease in throughput will be described.

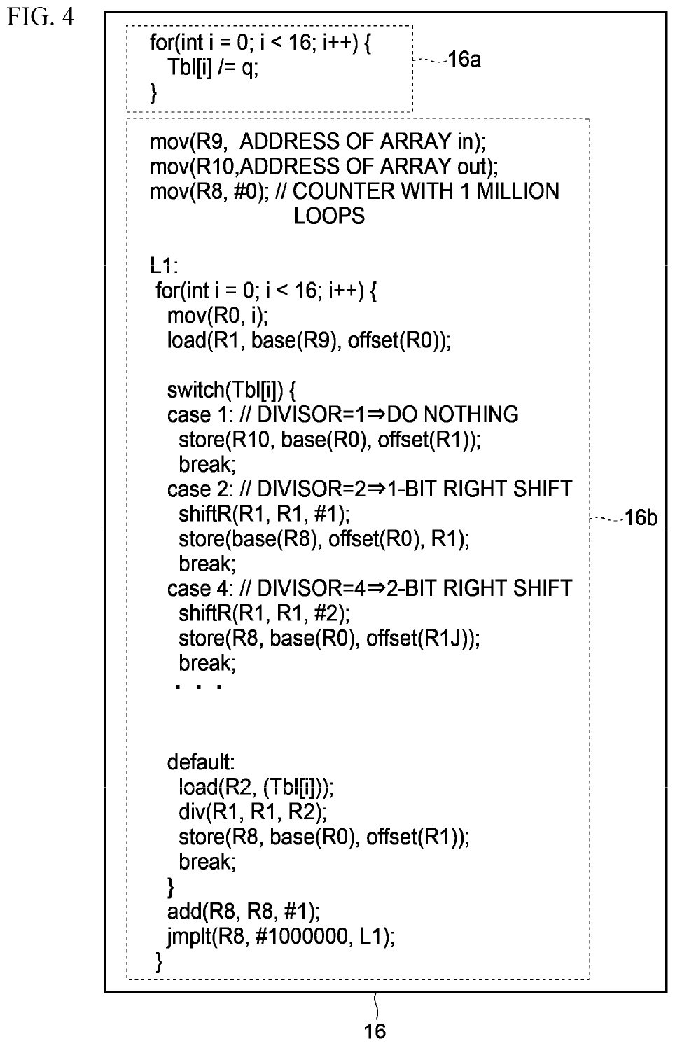

FIG. 4 is a diagram illustrating an example of an C++ pseudo source code 16 that is premised to be compiled with the JIT compiler technology.

The source code 16 is a code written by the developer so that the execution result thereof is the same as the execution result of the source code 10 of FIG. 1A. The source code 16 has a process 16a and a process 16b. The process 16a is a process of dividing each element of the array “Tbl” by the parameter “q”, as in the process 10a of the source code 10. Also, the process 16b is a process of dividing the element of the array “in” by the element of the array “Tbl” and storing the result in the array “out”, as in the process 10b of the source code 10.

In the process 16b, the developer writes a function such as “mov(R0, i)” whose function name is the same as the mnemonic. The function “mov(R0, i)” is a function that corresponds to the assembly “mov R0, #i” and writes the machine language that represents the process performed by “mov R0, #i” into a memory. Hereinafter, in this way, the function whose function name is the same as the mnemonic of the instruction, and which writes the machine language representing the process to be performed by the instruction into the memory, is called a mnemonic function.

The process 16b is a process of iterating and executing in[i]/Tbl[i] inside the for loop. However, in this example, the developer has written a switch statement, so that a different mnemonic function is executed depending on the value of the array Tbl[i] which is the divisor.

For example, when the value of Tbl[i] is “1”, the divisor for in[i] is “1”, so there is no need to do anything for in[i]. Therefore, in this case, no operation is performed on register R1 where the value of in[i] is stored, in “case 1”.

On the other hand, if the value of Tbl[i] is “2”, “shiftR(R1, R1, #1)” corresponding to a shiftR instruction is executed in “case 2”. This mnemonic function is a function that writes, to the memory, a machine language representing the process of shifting the contents of the register R1 to the right by one bit and writing the result to the register R1. Therefore, by executing “shiftR (R1, R1, #1)”, it is possible to perform a process equivalent to dividing in[i] stored in the register R1 by 2.

If the value of Tbl[i] is “4”, “shiftR(R1, R1, #2)” is executed in “case 4”. Thereby, the contents of register R1 can be shifted by two bits to the right, and it is possible to execute a process equivalent to dividing in[i] stored in the register R1 by four.

Then, if the value of Tbl[i] is not “1”, “2”, or “4”, “div(R1, R1, R2)” is executed in “default”. This mnemonic function is function that corresponds to the div instruction, and writes the value obtained by dividing the contents of the register R1 by the contents of the register R2 into the register R1.

According to such a source code 16, when the value of Tbl[i] is “1”, “2”, or “4”, a machine language equivalent to the shift instruction which has fewer execution cycles than the div instruction, and a machine language that do nothing are written to the memory. Then, the machine language equivalent to the div instruction is written to the memory only when the value of Tbl[i] is neither “1”, “2”, nor “4”.

The JIT compiler technology can speed up the execution speed of the program compared to the AOT compiler technology by writing an optimum machine language to reduce the number of execution cycles according to the values of parameters such as Tbl[i] in this way.

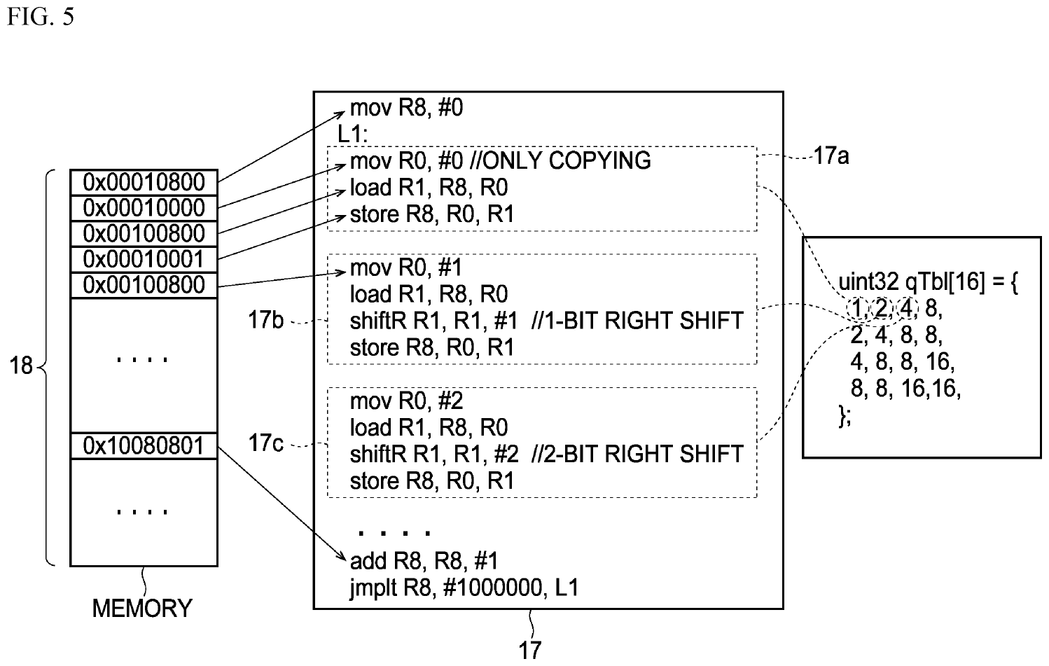

FIG. 5 is a schematic diagram illustrating a pseudo code of an assembly 17 obtained by compiling the source code 16 of FIG. 4 with the JIT compiler technology when the input parameter “q” is “8”. FIG. 5 also schematically illustrates the arrangement in memory of a machine language 18 obtained by compiling that assembly with an assembler.

As illustrated in FIG. 5, in the case of q=8, the respective elements of the array “Tbl” are “1”, “2”, and “4” in order from the top. Therefore, instruction strings 17a to 17c corresponding to the respective cases of “case 1”, “case 2”, and “case 4” in the source code 16 are described in the assembly 17. Then, the machine language 18 that represents the process of these instructions is placed in the memory.

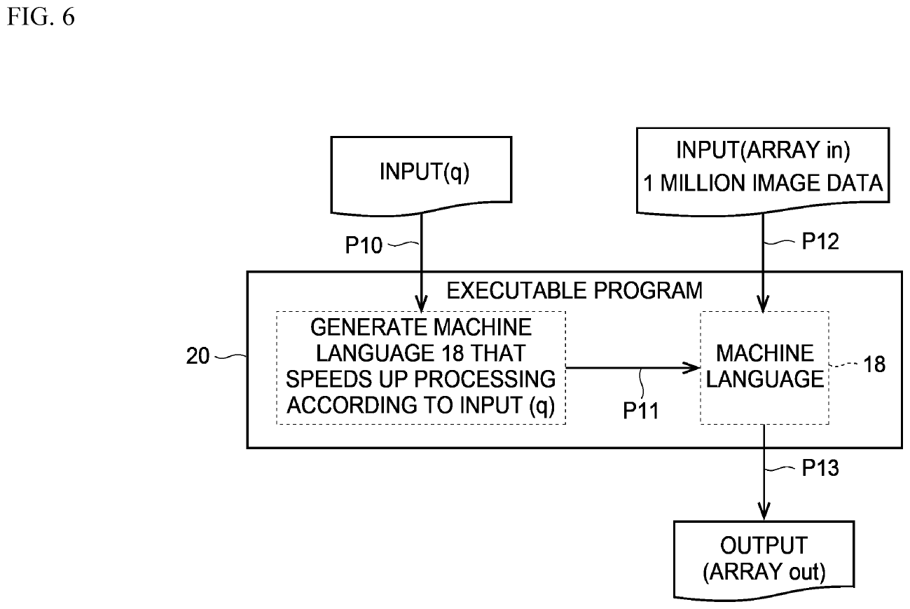

FIG. 6 is a schematic diagram illustrating the operation of an executable program 20 composed of a machine language obtained by compiling the source code 16 with JIT compiler technology.

As illustrated in FIG. 6, the executable program 20 first accepts the input parameter “q” (step P10). Next, the executable program 20 generates the machine language 18 that speeds up the process according to the value of the input parameter “q” (step P11). In the above example of FIG. 5, the machine language 18 suitable for the value of “Tbl[i]” is generated.

Then, the executable program 20 accepts the input of each element of the array “in”, which is the input data (step P12), and stores the result of the process in each element of the array “out” (step P13).

By generating the appropriate machine language 18 according to the value of the input parameter “q” in this way, the JIT compiler technology can speed up the execution speed of the program more than the AOT compiler technology.

By the way, in the target machine that executes the executable program obtained by the JIT compiler technology, SIMD (Single Instruction Multiple Data) instructions may be executed in order to perform large-scale operations in parallel.

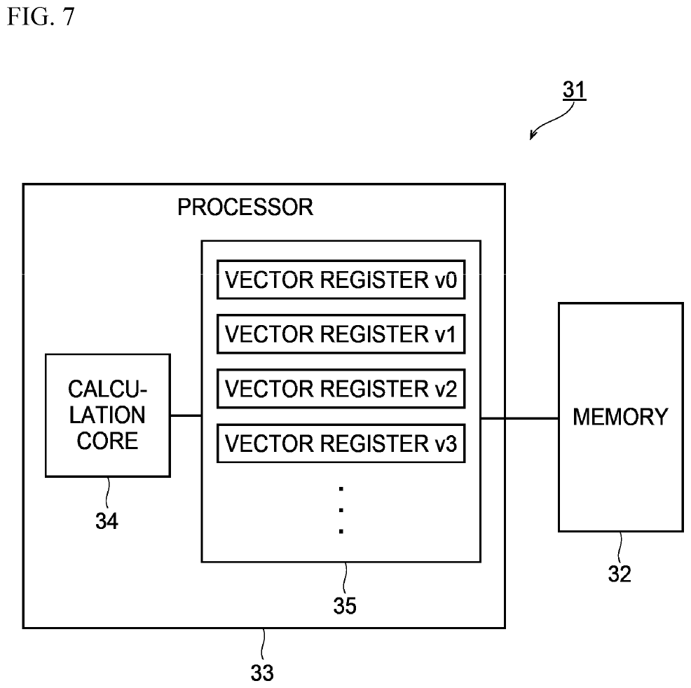

FIG. 7 is a hardware configuration diagram illustrating a target machine capable of executing the SIMD instruction.

A target machine 31 is a computer such as a server or a PC (Personal Computer), and has a memory 32 and a processor 33.

The memory 32 is a volatile memory such as a DRAM (Dynamic Random Access Memory) in which the executable program is expanded.

On the other hand, the processor 33 is hardware that executes the executable program in cooperation with the memory 32, and includes a calculation core 34 and a register file 35. The calculation core 34 is hardware such as an ALU (Arithmetic and Logic Unit) that performs arithmetic operation and logical operation. Further, the register file 35 is a storage element such as a SRAM (Static Random Access Memory) in which data subject to the arithmetic operation or the logical operation executed by the calculation core 34 is stored. In this example, a plurality of general-purpose vector registers vn which are identified by the index n (=0, 1, 2, . . . ) are provided in the register file 35. These vector registers vn are used to store vector data, and their size is 128 bits or 64 bits.

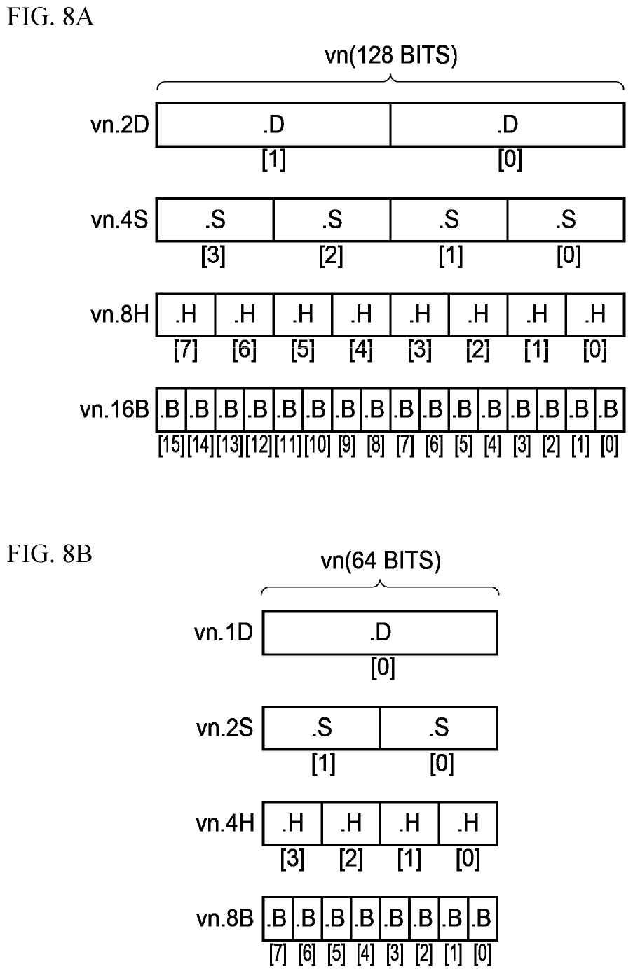

FIG. 8A is a schematic diagram illustrating formats of the assembly for specifying a 128-bit length vector register vn in AArch64 which is an instruction set of processor 33.

As illustrated in FIG. 8A, to specify a 128-bit length vector register vn(=0, 1, 2, . . . 31), the formats “vn.2D”, “vn.4S” “vn.8H”, and “vn.16B” of the assembly are adopted.

In this format, “vn” is a format that specifies a vector register vn with an index “n”. Then, “2D”, “4S”, “8H”, and “16B” following a dot “.” are formats indicating the number of elements included in one vector register vn and the size of one element. Each element is a storage unit for storing each component of the vector data. For example, the “2” in “2D” indicates that the number of elements is two, and the “D” indicates that the size of the element is a double word (64 bits).

Similarly, “4”, “8”, and “16” indicate that the number of elements is 4, 8, and 16, respectively. And, “S”, “H”, and “B” indicate that the size of the element is a single word (32 bits), a half word (16 bits), and a byte (8 bits), respectively.

Thus, in this format, the vector register, the number of elements and the size of the element are specified by a character string such as “vn.2D” in which “vn” and “2D” are linked with a dot “.”.

A format “vn.4S[i]” is also used to specify one of the plurality of elements of a single vector register. Square brackets “[ ]” are lexical tokens that specify a position of the element. Also, the “i” inside the square brackets is a number that uniquely identifies the location of the element. Here, “i” is arranged in an ascending order from a lower bit of the vector register vn. For example, “vn.4S[0]” indicates the lowest element of the four elements, and “vn.4S[1]” indicates the second element from the lowest.

FIG. 8B is a schematic diagram illustrating a format for specifying a 64-bit length vector register vn (=0, 1, 2, . . . 31) in AArch64.

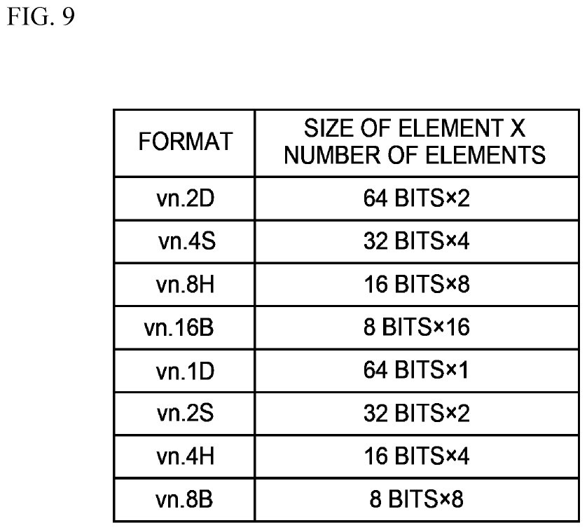

Also in this case, the vector register, the number of elements, and the size of the element are specified using the same syntax as the format for specifying the 128-bit length vector register vn. For example, “vn.8B” is a format that specifies a vector register vn having 8 elements and an element size of 1 byte. FIG. 9 is a diagram summarizing the size of the element and the number of elements for each of above formats.

As illustrated in FIG. 9, this format allows a plurality of designations with different sizes and numbers of elements for the same vector register vn.

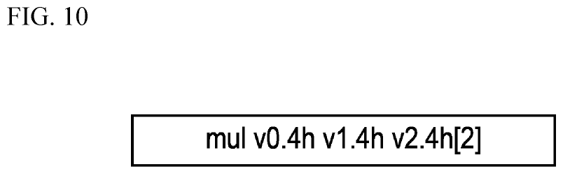

FIG. 10 is a schematic diagram illustrating a method of describing the assembly using the formats of FIGS. 8A and 8B.

Here, a description example of the mul instruction will be described. The mul instruction is an instruction that takes three operands, and the vector register is specified for each operand. In this example, the content of each of the four elements in “v1.4h” is multiplied by the content of “v2.4h[2]” and the result is stored in each of the four elements in “v0.4h”.

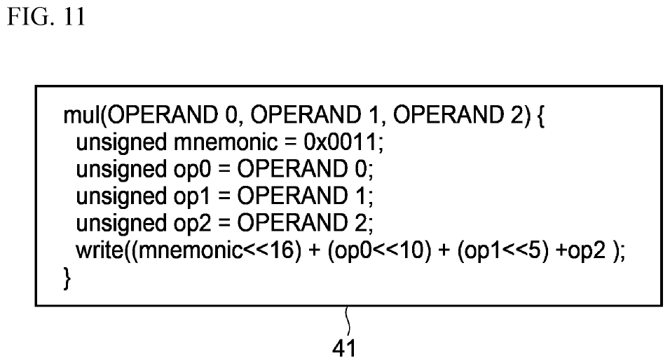

FIG. 11 is a diagram illustrating an example of a C++ pseudo source code of a mnemonic function mul corresponding to the mul instruction.

A source code 41 is a source code for defining the mnemonic function mul, and is generated in advance by the developer. Three arguments of that mnemonic function mul are “operand 0”, “operand 1” and “operand 2” which the mul instruction takes.

A code to write the machine language representing the process of the mul instruction to memory 32 is described inside the mnemonic function mul. Here, it is assumed that the instruction length of the mul instruction is 32 bits, and the opcode of the mul instruction is 16 bits and is 0x0011. In this case, the developer writes s statement “unsigned mnemonic=0x0001;” that assigns the opcode 0x0011 to a variable mnemonic into the body of the mnemonic function mul. Similarly, the developer writes a statement that assigns “operand 0”, “operand 1” and “operand 2” to respective variables op0, op1, and op2 into the body of the mnemonic function mul.

Then, after these statements, the developer writes a statement “write ((mnemonic<<16)+(op0<<10)+(op1<<5)+op2);”. In this example, a bitwise sum of a bit string acquired by shifting the value of mnemonic to the left by 16 bits, a value acquired by shifting the value of the variable op0 to the left by 10 bits, a value acquired by shifting the value of the variable op to the left by 5 bits, and the variable op2 is taken. Then, the bitwise sum becomes the argument of a function write. In this bit string, the first 16 bits are the opcode of the mov instruction, followed by the bit strings for respective variables op0, op1, and op2.

If the arguments of this mnemonic function mul can be written in the assembly-like syntax in FIG. 10, the source code can be written in the syntax of the assembly familiar to the developer, making the mnemonic function easy to use for the developer.

However, in C++, the dot “.” is a lexical token indicating a member of a class, and the square brackets “[ ]” are a lexical token indicating an array, so these lexical tokens cannot be used immediately as arguments of the mnemonic function mul.

Therefore, in this example, the argument of the mnemonic function can be described in the assembly-like syntax by using the syntax that specifies the member of the class in an object-oriented language such as C++ as follows.

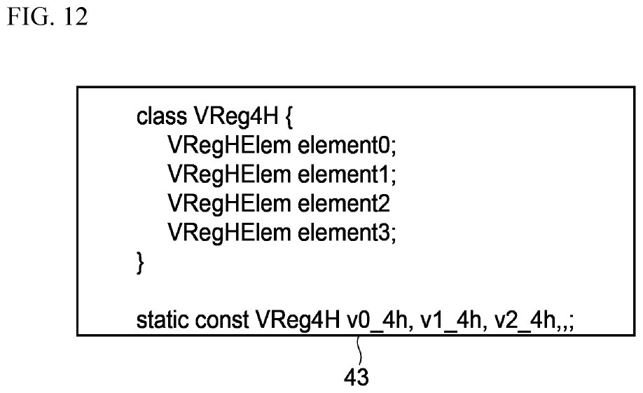

FIG. 12 is a diagram illustrating a pseudo source code 43 of a C++ class definition previously written by a developer to allow him to write the arguments of the mnemonic function in the assembly-like syntax.

Here, as illustrated in FIG. 12, a VReg4H class is defined as a class corresponding to the above-mentioned format “vn.4h” (n=0, 1, . . . 31). The members of the VReg4H class are “element0”, “element1”, “element2”, and “element3” corresponding to four elements specified in the format “vn.4h”. The type of these members shall be an appropriate type “VRegHElem” defined in advance.

Then, a statement “static const VReg4H v0_4h, v1_4h, v2_4h . . . ;” generates three instances “v0_4h”, “v1_4h”, and “v2_4h” of the VRreg4H class. These instances correspond to “v0.4h”, “v1.4h”, and “v2.4h” described in the assembly syntax, respectively. By using an underbar “_” instead of the dot “.” in this way, in this example, the description imitates the syntax of the assembly.

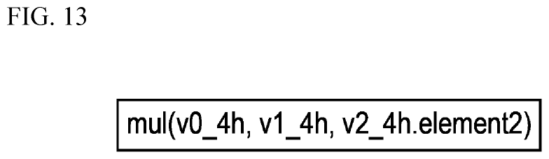

FIG. 13 is a diagram illustrating a description example of the arguments of the mnemonic function mul in this case.

By generating the instances “v0_4h”, “v1_4h”, and “v2_4h” in the source code 43 as described above, the instances “v0_4h” and “v1_4h” can be used as a first argument and a second argument of the mnemonic function mul. Further, as a third argument, “v2_4h.element2” indicating a member of the instance “v2_4h” can be used.

However, the description of such an argument is significantly different from the description “mul v0.4h v1.4h v2.4h [2]” of the assembly illustrated in FIG. 10. Therefore, if the developer is not familiar with the class definition illustrated in FIG. 13, mistakes in writing the code and the trouble of re-examining the definition occur, which reduces the efficiency of developing the source code for the application program. In addition, the following problem also occurs in this example.

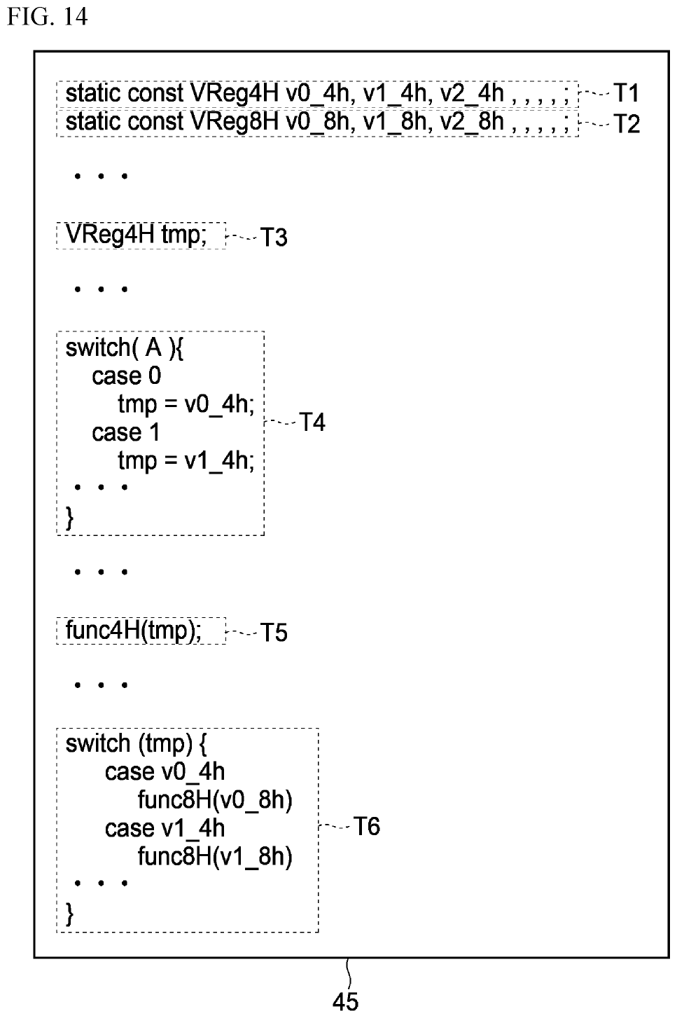

FIG. 14 is a schematic diagram of a C++ pseudo source code for explaining the problem.

A source code 45 is a source code for the application program written by the developer. In this example, in a code T1, the instances “v0_4h”, “v1_4h”, and “v2_4h” of the VReg4H class are generated. Similarly, in a code T2, instances “v0_8h”, “v1_8h”, “v2_8h” of a VReg8H class are generated. The VReg8H class is a class corresponding to the above-mentioned format “vn.8h” (n=0, 1, . . . 31).

A code T3 is a code that declares a VReg4H type variable “tmp”.

A code T4 is a code for changing the vector register of an operation target according to a value of a parameter A. For example, when the value of the parameter A is “0”, a vector register v0 represented by “v0_4h” is the operation target, and “v0_4h” is stored in the variable “tmp”. On the other hand, when the value of the parameter A is “1”, a vector register v1 represented by “v1_4h” is the operation target, and “v1_4h” is stored in the variable “tmp”.

A code T5 is a code that calls a function func4H that processes the variable “tmp”. It is assumed that the function func4H has one argument and its type is a VReg4H type. In the above code T4, an instance of the VReg4H type is stored in the variable “tmp” regardless of the value of parameter A, so the variable “tmp” can be passed to the function func4H without type conversion.

On the other hand, a code T6 is a code for processing the same register as in the code T4 in a format different from that of the code T4.

For example, when “v0_4h” is stored in the variable “tmp”, a function func8H that processes the format “v0_8h” different from this is called. It is assumed that the function func8H has one argument and its type is a VReg8H type. Both of “v0_4h” and “v0_8h” correspond to the same vector register v0, but their types are different between VReg4H type and VReg8H type. Therefore, for example, the format cannot be described as “func8H(v0_4h)”, but must be described as “func8H(v0_8h)” as illustrated in this example.

In this way, when the format of the process target is “v0_8h” of the VReg8H type, it is necessary to control to call the function “func8H” that takes the VReg8H type as an argument, and hence coding becomes complicated because of the effort to write the code to realize the control.

Similarly, when “v1_4h” is stored in the variable “tmp”, the format cannot be described as “func8H(v1_4h)”, but must be described as “func8H(v1_8h)” as illustrated in this example, which still makes the coding complicated. Hereinafter, each embodiment will be described.

### First Embodiment

In the present embodiment, the source code can be described in the assembly-like syntax as follows.

### (Overall Configuration)

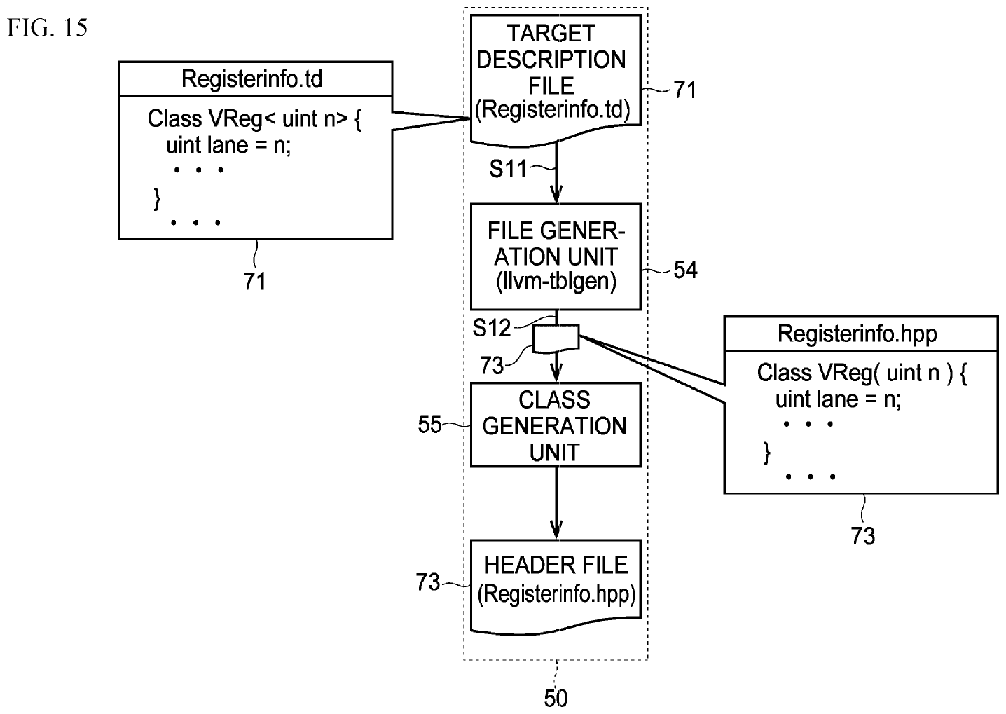

FIG. 15 is a schematic diagram illustrating the operation of an information processing apparatus according to the present embodiment. An information processing apparatus 50 is a computer such as a PC or a server, and has a file generation unit 54 for generating a C++ header file 73 and a class generation unit 55 which is a tool for generating the class in the header file 73. In FIG. 15, the flow of the file is represented by arrows, and the processes performed by the file generation unit 54 and the class generation unit 55 using the file are schematically illustrated.

When generating the header file 73, the information processing apparatus 50 reads a target description file 71 (step S11). The target description file 71 is a source file in a td format in which a template of the class is written by the developer. Here, the file name is “Registerinfo.td”.

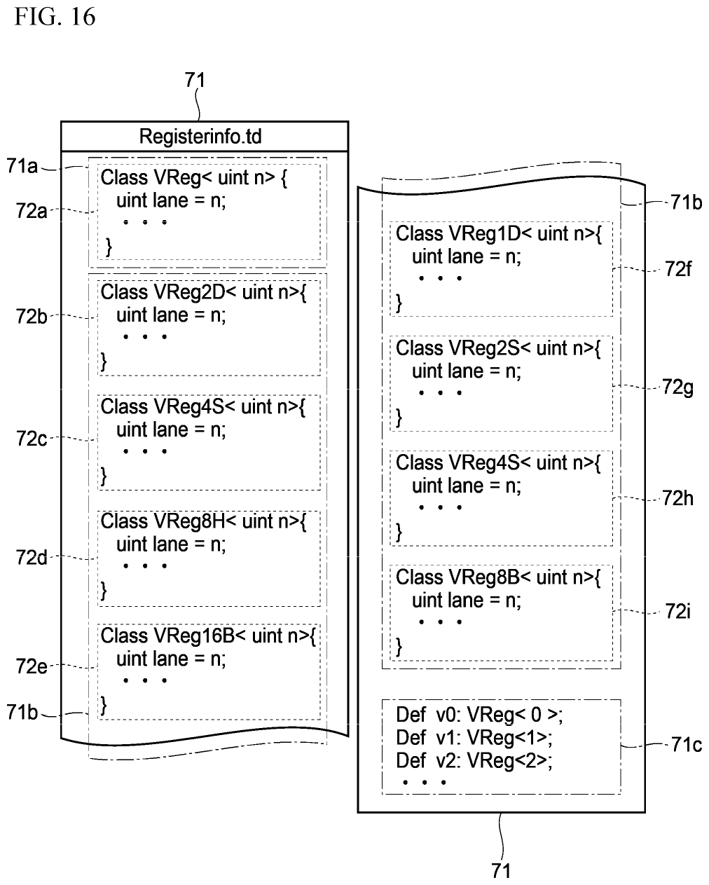

FIG. 16 is a schematic diagram illustrating a C++ pseudo source code described in the target description file 71.

As illustrated in FIG. 16, templates 71a and 71b of respective classes are described in the target description file 71.

Here, the template 71a is a template of a VReg class 72a. The VReg class 72a is a class representing a format “VReg” that specifies one of the plurality of vector registers vn (n=0, 1, . . . 31). Then, an index “n” of the instance of this VReg class 72a is equal to the index of the vector register vn.

Further, the template 71b includes templates of classes 72b to 72i representing respective formats of FIG. 9 In this example, in the class name “VReg2D” of VReg2D class 72b, the number “2” of the character string “2D” excluding “VReg” indicates the number of elements, and “D” following this indicates the size of the element. Thereby, the VReg2D class 72b becomes a class representing the format “0.2D” in FIG. 9.

Similarly, a VReg4S class 72c is a class representing a format “0.4S”, and a VReg8H class 72d is a class representing a format “0.8H”. Then, a VReg8H class 72e is a class representing a format “0.8H”.

Further, the target description file 71 also describes a process 71c for generating the instance of the above-mentioned VReg class. A statement “Def vn: VReg <n>;” (n=0, 1, 2, . . . 31) in this process 71c is a statement for generating the instance of the VReg class corresponding to the vector register vn.

Again, FIG. 15 is referred to. Next, the file generation unit 54 of the information processing apparatus 50 generates the header file 73 from the target description file 71 (step S12). The file generation unit 54 is a code generator that generates a hpp file from a td file.

Such a code generator is, for example, llvm-tblgen. When using llvm-tblgen, the developer enters “llvm-tblegen -o=Registerinfo.hpp Registerinfo.td” in a command line of the information processing apparatus 50, and hence the header file 73 with a file name “Registerinfo.hpp” is generated.

The header file 73 is an hpp format file in which the definitions of all the classes described in the target description file 71 are generated.

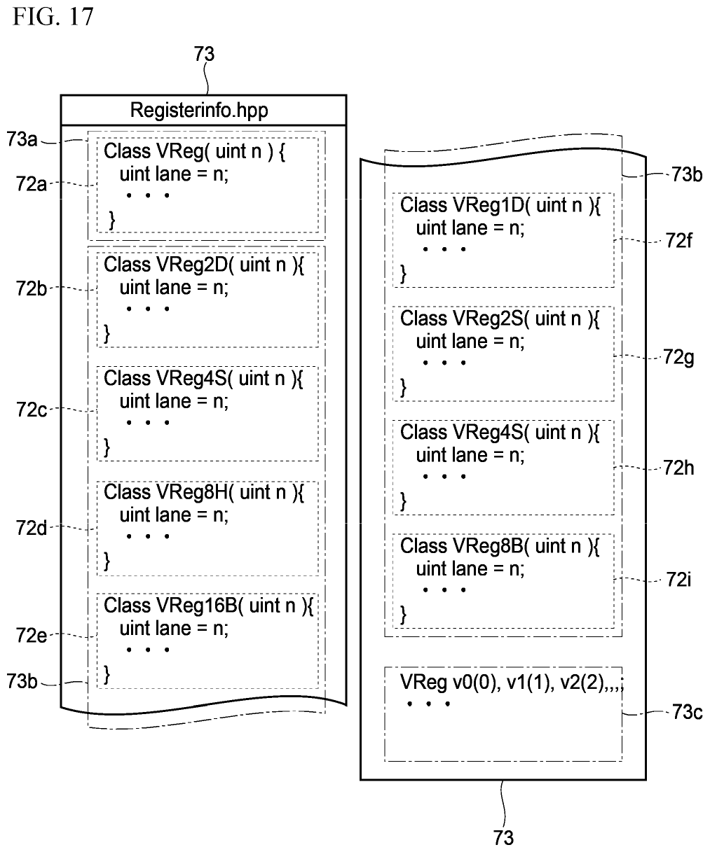

FIG. 17 is a schematic diagram illustrating a C++ pseudo source code described in the header file 73.

As illustrated in FIG. 17, the header file 73 describes the definitions 73a and 73b of the respective classes. Here, the definition 73a is the definition of the VReg class 72a, and the definition 73b is the definitions of the classes 72b to 72i.

Further, the header file 73 also describes the process 73c for generating the instance of the VReg class 72a. The process 73c is a process generated by the process 71c of the target description file 71, and here, the respective instances “v0(0)”, “v1(1)”, “v2(2)”, . . . “v31(31)” are generated.

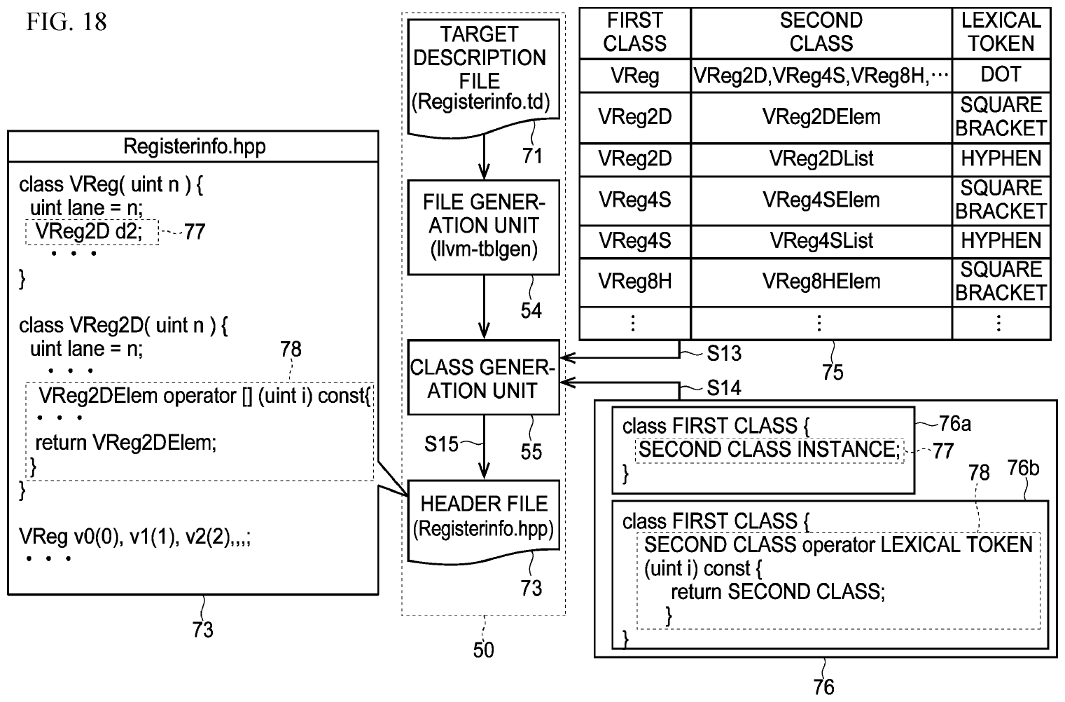

Subsequent operations of the information processing apparatus 50 will be explained with reference to FIG. 18.

FIG. 18 is a schematic diagram illustrating the operation of the information processing apparatus 50 according to the present embodiment. First, the class generation unit 55 of the information processing apparatus 50 refers to format rule information 75 (step S13). The format rule information 75 is a table in which the first class, the second class, and the lexical token are associated with each other, and the format rule information 75 is generated in advance by the developer.

Here, the first class is the classes 72a to 72i in FIG. 17. All of these classes 72a to 72i are classes representing formats related to the vector registers vn. For example, the VReg class 72a is the format that specifies one of the plurality of vector registers vn (n=0, 1, 2, . . . 31). The remaining classes 72b to 72i are formats for specifying the number and the size of the elements included in the vector register vn.

As an example, the VReg2D class 72b is a class in which “2” is specified as the number of elements and the double word (64 bits) is specified as the size of the elements. The VReg4S class is a class in which “4” is specified as the number of elements and the single word (32 bits) is specified as the size of the elements.

When the first class is the VReg class 72a as illustrated in a first line of the format rule information 75, each of the remaining classes 72b to 72i is stored in the format rule information 75 as the second class, and the dot “.” is stored in the lexical token.

Further, in the second and subsequent lines of the format rule information 75, any of the classes 72b to 72i is stored as the first class. Then, a class including the character strings “Elem” and “List” such as VReg8BElem class and VReg8BList class is stored as the second class.

A class containing the character string “Elem” is a class representing a format for specifying an element of the vector register. For example, the VReg8BElem class is a format for specifying any of eight elements represented by the format “vn.8B”. In this case, the square brackets “[ ]” for specifying the element are stored in the “lexical” of the format rule information 75.

Further, a class including the character string “List” is a class representing a format for specifying a list of vector registers. For example, the VReg8BList class is a format for specifying the list of vector registers vn represented by the format “vn.8B”. In this case, the hyphen “-” indicating the list is stored in the “lexical” of the format rule information 75.

In any line of the format rule information 75, the second class is a child class that inherits the first class. For example, the VReg2D class, the VReg4S class, the VReg8H class, and the like on the first line are child classes of the VReg class. Similarly, the VReg2DElem class on the second line is a child class of the VReg2D class, and the VReg2DList class on the third line is a child class of the VReg2D class. The same applies to the fourth and subsequent lines.

If the instance of the second class is a member variable of the first class, the dot “.” can be used as the C++ syntax to specify its child class. For example, if the instance of the VReg class in the first line of the format rule information 75 is “vn” and the instance of the VReg2D class is “2d”, the notation “vn.2d” similar to the syntax of the assembly is possible.

The class generation unit 55 acquires the first class, the second class, and the lexical token which are associated with each other by referring to such format rule information 75.

Next, the class generation unit 55 refers to the template information 76 (step S14).

The template information 76 is information in which the first template 76a and the second template 76b, which are the templates of the source code described in the header file 73, are associated with the lexical token, and the template information 76 is generated in advance by the developer.

Here, the first template 76a is a template corresponding to the lexical dot “.”, and has a first code 77 inside the first class. The first code 77 is not particularly limited, but in the present embodiment, a sentence “SECOND CLASS INSTANCE;” for generating an instance of the second class is referred to as the first code 77.

Further, the second template 76b is a template corresponding to each lexical token of the square bracket “[ ]” and the hyphen “-”, and has a second code 78 in which a member function “operator” that overloads these lexical tokens is described. Multiple definitions, also called overloading, are a mechanism that defines multiple definitions for the same lexical token and selects one definition according to the context at the time of the program execution.

Then, “operator” is a reserved word in C++ for this overloading. Here, the developer generates the second template 76b so that the member function “operator” becomes the member of the first class.

The argument of the member function “operator” is an integer “i”, and the return value is the second class. Thereby, when the lexical token is square brackets “[ ]” and the integer “i” is “2”, for example, the member function “operator” enables the expression with square brackets “[2]”, and the position of the element can be expressed with the square brackets “[ ]” as in the syntax of the assembly in FIGS. 8A and 8B.

Then, the class generation unit 55 acquires a template corresponding to the lexical token acquired in step S13 among the first template 76a and the second template 76b.

Next, the class generation unit 55 generates, in the header file 73, a code that assigns the second class to any one of the first code 77 and the second code 78 described in the acquired template (step S15). The assignment way will be described by taking, as an example, a case where each of “VReg”, “VReg2D”, and “dot” in the first line of the format rule information 75 is acquired in step S13. In this case, since the lexical token is “dot”, the class generation unit 55 acquires the first template 76a corresponding to the “dot” in step S14.

Then, in step S15, the class generation unit 55 assigns the character string “VReg2D” representing the second class to the “second class” of the first code 77. At the same time, the class generation unit 55 assigns the character string “d2” to the “instance” of the first code 77. After that, the class generation unit 55 generates the first code 77 to which the character strings “VReg2D” and “d2” are assigned in this way, in the header file 73. A generation location is inside the VReg class that is associated with the VReg2D class in the format rule information 75.

On the other hand, consider the case where the class generation unit 55 acquires each of “VReg2D”, “VReg2DElem”, and “square brackets” in the second line of the format rule information 75 in step S13. In this case, since the lexical token is “square brackets”, the class generation unit 55 acquires the second template 76b corresponding to the “square brackets” in step S14.

Then, in step S15, the class generation unit 55 assigns the string “VReg2DElem” representing the second class to the “second class” of the second code 78. At the same time, the class generation unit 55 assigns the square brackets “[ ]” to the “lexical token” of the second code 78. After that, the class generation unit 55 generates the second code 78 to which the character strings “VReg2DElem” and the lexical token “[ ]” are assigned in this way, in the header file 73. A generation location is inside the VReg2D class that is associated with the VReg2DELem class in the format rule information 75.

When the lexical token is “hyphen” as in the third line of the format rule information 75, the class generation unit 55 assigns “-” to the “lexical token” of the second code 78.

Then, the class generation 55 generates the first code 77 and the second code 78 inside all the first classes stored in the format rule information 75 by reading all the lines of the format rule information 75.

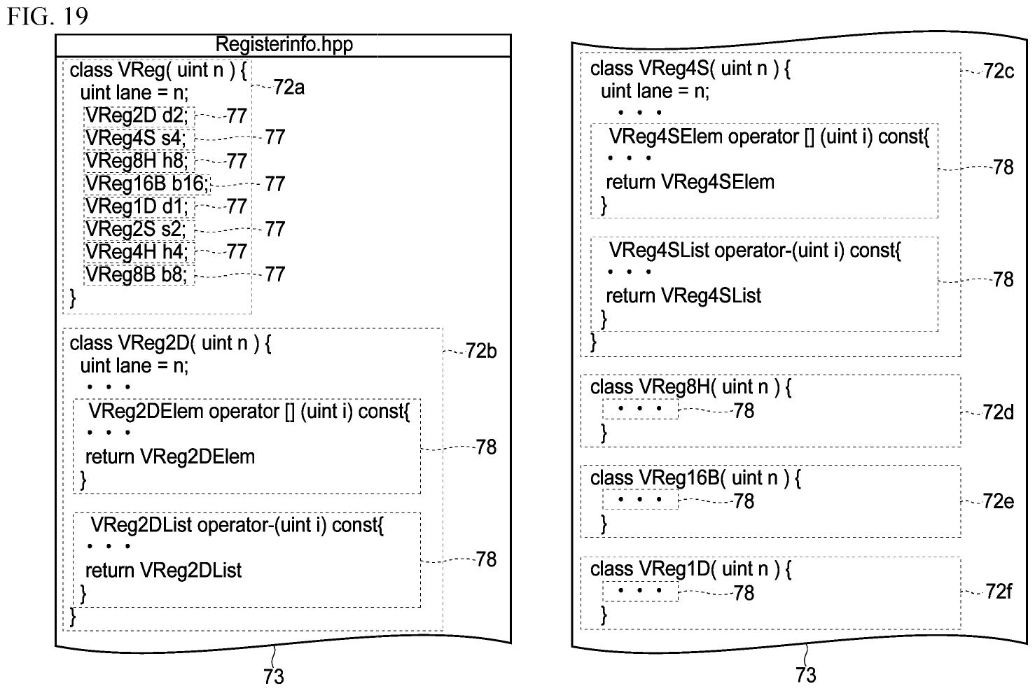

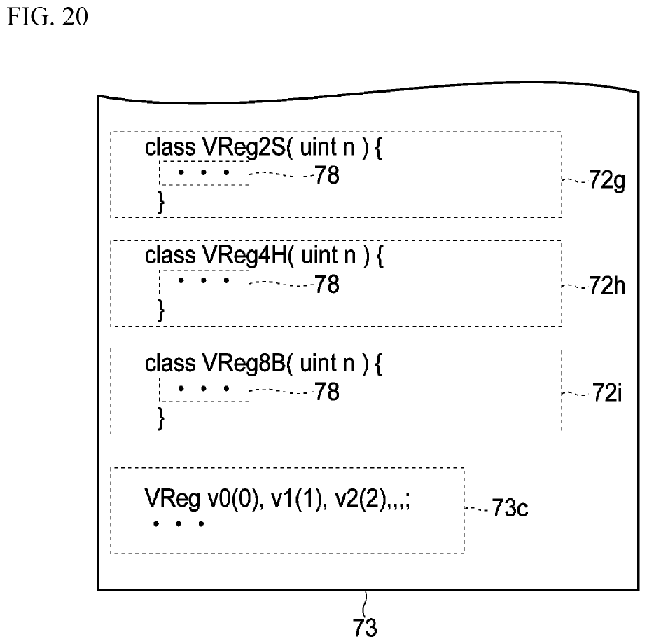

FIGS. 19 and 20 are schematic diagrams illustrating a C++ pseudo source code of the header file 73 generated by the class generation unit 55 in this way.

As illustrated in FIGS. 19 and 20, classes 72a to 72i are generated in advance in the header file 73 by the file generation unit 54, and the class generation unit 55 generates the first code 77 and the second code 78 inside these classes.

For example, the VReg class 72a is the first class in the first line of the format rule information 75 (see FIG. 18), and a plurality of first codes 77 are generated inside the first class. Each of these first codes 77 corresponds to the plurality of second classes “VReg2D”, “VReg4S”, “VReg8B” in the first line of the format rule information 75, respectively, and is a code that generates the instances “d2”, “s4”, . . . “b8” of these classes.

Further, the classes 72b to 72i are the first classes after the second line of the format rule information 75, and the second code 78 is generated inside each of the classes 72b to 72i. This completes the basic process performed by the information processing apparatus 50.

Next, a development environment of an application program using the header file 73 will be described.

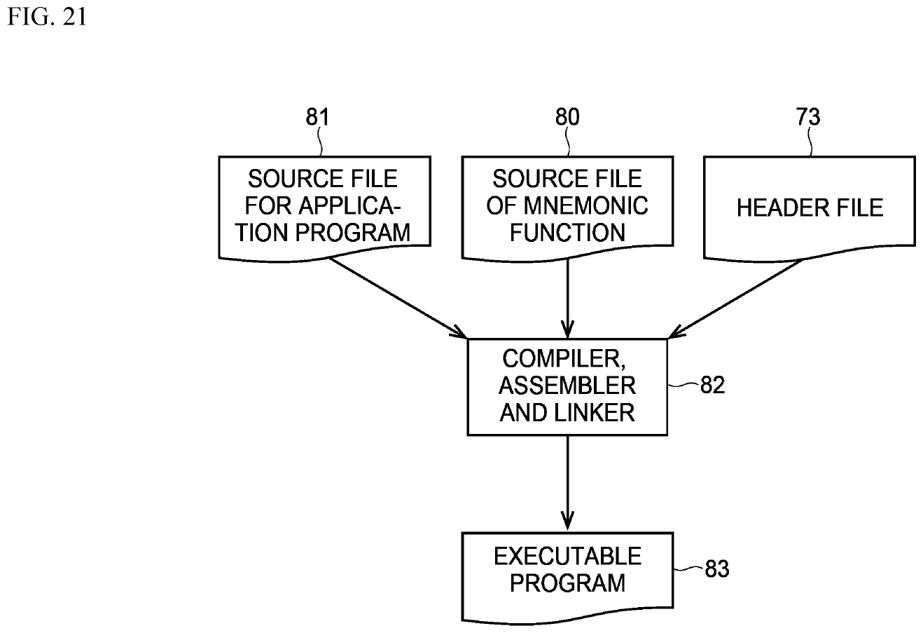

FIG. 21 is a schematic diagram illustrating the development environment according to the present embodiment. In this example, it is assumed that the development environment is constructed inside the information processing apparatus 50. In that case, the class generation unit 55 generates the header file 73 based on the format rule information 75 and the template information 76 as described above.

On the other hand, the developer generates a source file 80 of the mnemonic function using, for example, C++. The source file 80 is a file in which the source code 41 for defining the mnemonic function as illustrated in FIG. 11 is described. The developer describes the definition of all the mnemonic functions corresponding to all the instructions included in the instruction set of the processor 33 (see FIG. 7) in the source file 80 in advance.

Further, the developer generates a source file 81 for the application program. The source file 81 is a C++ or other file that is premised on being compiled by the JIT compiler technology. In the source file 81, the mnemonic functions in the source file 80 are also described in addition to the C++ library functions.

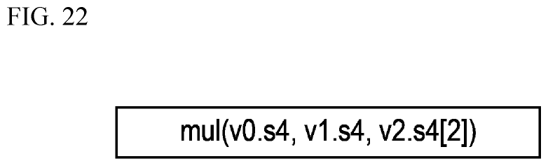

FIG. 22 is a diagram illustrating a description example of the mnemonic function mul in the source file 81. Here, a description is given of the case where “4s” which is the instance of the VReg4S class is used as the argument of the mnemonic function mul, but the instance of another class such as VReg4H may be used as the argument of the mnemonic function mul.

As illustrated in FIG. 22, the first argument of this mnemonic function mul is “v0.s4”. The “v0” in the notation is defined as the instance of the VReg class 72a in the process 73c (see FIG. 20) of the header file 73. Then, as illustrated in FIG. 19, “s4” is defined as the instance of the VReg4S class which is the member of the VReg class 72a in the header file 73.

Therefore, the notation “v0.s4” using the dot “.” means “s4” which is a member of “v0”, resulting in a correct notation in the C++ syntax. The same applies to the second argument “v2.s4”.

Further, as illustrated in FIG. 19, the member function “operator” that overloads the lexical token “[ ]” is defined in the VReg4S class 72c of the header file 73. Therefore, the third argument “v2.54[2]” of the mnemonic function mul means that “54[2]”, which is the result of passing “2” to the member function “operator”, is a member of the instance “v2” of the VReg class, resulting in the correct notation in C++ syntax.

As described above, in the present embodiment, the dots “.”, the square brackets “[ ]”, and the like can be used in the source file 81 for the application program, allowing the description of the assembly-like syntax such as “v0.s4” and “v2.54[2]”. Similarly, the member function “operator” that overloads the hyphen “-” makes it possible to describe a list in the assembly, such as “v0.16b-v3.16b”, in the source file 81.

Again, FIG. 21 is referred to. After preparing the header file 73 and the source files 80 and 81 as described above, a program group 82 including the compiler, the assembler and the linker builds under an instruction of the developer. In the build, the compiler included in the program group 82 compiles the source file 81.

At this time, the compiler reads the header file 73 and each of the source file 80 and 81, and outputs an intermediate language file of the assembly. Then, the assembler converts the intermediate language file into the machine language to generate an object file.

Then, the linker links the object file with the various libraries to generate an executable program 83 in a binary format that can be executed by the processor 33.

Thereby, the executable program 83 can be generated from the source file 81 for the application program.

Since the executable program 83 generates machine words as described in FIG. 5 according to the parameters at runtime using JIT compiler technology, it is particularly effective in speeding up application programs that require a large number of loops and large-scale operations, such as deep learning and image processing. Similarly, the executable program 83 can also speed up application programs used in image processing such as video compression, encryption processing, decryption processing, blockchain technology and the like.

According to the present embodiment described above, as illustrated in FIG. 18, the developer stores the first class and the second class representing each format of the vector registers in association with the lexical token in the format rule information 75. Then, the class generation unit 55 generates any one of the first code 77 that generates the instance of the second class and the second code 78 that overloads each lexical token with the member function “operator”, in the header file 73 according to the lexical tokens obtained from the format rule information 75.

Thereby, the respective lexical tokens such as the dot “.” and the square brackets “[ ]”, and the hyphen “-” in the format rule information 75 are already defined, and hence the developer can write these lexical tokens in the source file 81. As a result, it is possible to write the arguments of mnemonic functions using the assembly-like syntax familiar to the developer, thus eliminating the need for the developer to learn a new syntax and reducing a burden on the developer. Moreover, since the developer can write the source code in the source file 81 for the application program with this familiar syntax, bugs are less likely to occur in the executable program 83.

Thereby, the time for wastefully executing the buggy executable program 83 on the target machine 31 can be reduced, and the wasteful consumption of the hardware resources of the target machine 31 can be improved.

In particular, in this example, the format for specifying the vector register vn is represented by the VReg class, and the format for specifying the number and the size of elements included in the vector register is represented by the VReg2D class which inherits the VReg class. By setting the instance of the VReg2D class as the member variable of the VReg class, it is possible to use a notation such as “vn.2d” in which the character string “vn” that specifies the vector register vn, and the character string “2d” that specifies the number and the size of elements are linked with the dot “.”, in the source file 81.

Furthermore, in the present embodiment, the member function “operator” returns types such as VReg2DElem and VReg2DList classes that inherit the VReg2D class. Therefore, it is possible to use the square brackets “[ ]” and the hyphen “-” which the member function “operator” overloads, such as “v0.2d[2]” and “v0.2d-V3.2d”, in the source file 81.

Furthermore, in this example, the developer prepares templates 76a, 76b for the respective codes 77, 78 in the template information 76 in advance, and the class generation unit 55 generates the code in the header file 73 by assigning the second class to each template. Therefore, it is not necessary for the class generation unit 55 to generate all of the codes 77 and 78, and the time required for code generation can be reduced.

Further, according to the present embodiment, even when the same register is processed in different formats, there is an advantage that the complicated coding as illustrated in FIG. 14 can be avoided as follows.

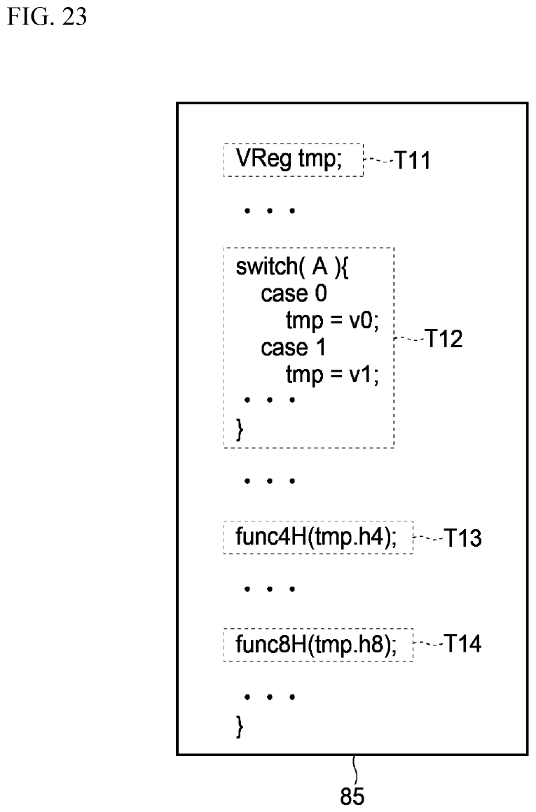

FIG. 23 is a schematic diagram illustrating a C++ pseudo source code for explaining the advantage.

This source code 85 is a C++ source code written by the developer in the source file 81 for the application program (see FIG. 21), and is a program for realizing the same process as the source code 45 in FIG. 14.

In this example, in a code T11, an instance “tmp” of the VReg class is generated.

Further, a code T12 is a code for changing the vector register of the operation target according to the value of the parameter A. Here, when the parameter A is “0”, an instance “v0” representing the 0th vector register v0 is stored in the variable “tmp”. Then, when the parameter A is “1”, an instance “v1” representing the first vector register v1 is stored in the variable “tmp”. As illustrated in FIG. 20, each of the instances “v0” and “v1” is defined as the instance of the VReg class in the process 73c of the header file 73.

Then, a code T13 is a code that calls the function func4H that processes a variable “tmp.h4”. Here, when the instance “v0” is stored in the variable “tmp”, the variable “tmp.h4” represents an instance corresponding to a format “v0.4H” that divides the vector register v0 into four elements.

Here, it is assumed that a type of the argument of the function func4H is a VReg4H type, as in the example of FIG. 14. In this case, since “h4” is defined as an instance of the VReg4H class in the header file 73 (see FIG. 19), the type of the variable “tmp.h4” is also the VReg4H type, and the argument of the function func4H and the type of the variable “tmp.h4” match. Therefore, the variable “tmp.h4” can be passed to the function func4H without type conversion.

On the other hand, a code T14 is a code that calls the function func8H that processes a variable “tmp.h8”. When the instance “v0” is stored in the variable “tmp”, the variable “tmp.h8” represents an instance corresponding to a format “v0.8H” that divides the vector register v0 into 8 elements.

Also, it is assumed that a type of the argument of the function func8H is a VReg8H type. Since “h8” is defined as an instance of the VReg8H class in the header file 73 (see FIG. 19), the type of the variable “tmp.h8” is also the VReg8H type, and the argument of the function func8H and the type of the variable “tmp.h8” match. Therefore, the variable “tmp.h8” can be passed to the function func8H without type conversion.

As described above, according to the present embodiment, the respective instances “h4” and “h8” of the VReg4H and VReg8H types are generated as members of the VReg class in the header file 73. Therefore, it is possible to represent the VReg4H class and the VReg8H class corresponding to different formats related to the same vector register v0 simply by changing the type of the member of “tmp” of the VReg type, such as “tmp.h4” and “tmp.h8”. As a result, it is not necessary to change the function to be used according to the format as in the example of FIG. 14, and the coding can be simplified.

### (Functional Configuration)

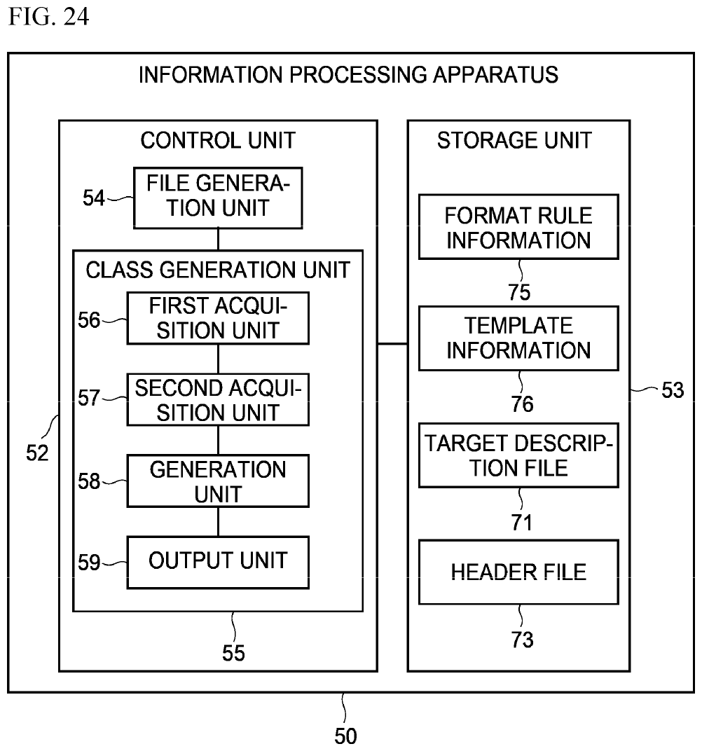

Next, the functional configuration of the information processing apparatus 50 according to the present embodiment will be described. FIG. 24 is a functional configuration diagram illustrating the information processing apparatus 50 according to the present embodiment. As illustrated in FIG. 24, the information processing apparatus 50 includes a control unit 52 and a storage unit 53.

The storage unit 53 is a processing unit realized by a storage device such as an HDD (Hard Disk Drive) or a memory such as a DRAM, and stores the format rule information 75, the template information 76, the target description file 71, and the header file 73. Here, the target description file 71, the format rule information 75, and the template information 76 are stored in the storage unit 53 in advance by the developer.

Also, the control unit 52 is a processing unit that controls the entire information processing apparatus 50, and includes the file generation unit 54 and the class generation unit 55.

The file generation unit 54 is a code generator such as llvm-tblgen as described above, and generates the header file 73 from the target description file 71.

Further, the class generation unit 55 is a processing unit that generates a class in the header file 73 generated by the file generation unit 54. In this example, the class generation unit 55 includes a first acquisition unit 56, a second acquisition unit 57, a generation unit 58, and an output unit 59.

The first acquisition unit 56 is a processing unit that acquires the first class, the second class, and the lexical token which are associated with each other by referring to the format rule information 75 of FIG. 18. Further, the second acquisition unit 57 is a processing unit that acquires a template corresponding to the lexical token acquired by the first acquisition unit 56 among the templates 76a and 76b by referring to the template information 76 in FIG. 18.

On the other hand, the generation unit 58 generates any one of the first code 77 and the second code 78 included in the template acquired by the second acquisition unit 57 inside each class of the header file 73 according to the lexicon acquired by the first acquisition unit 56. As an example, the generation unit 58 generates a code that assigns the second class to any one of the first code 77 and the second code 78 in the acquired template, and generates the code inside the first class of the header file 73.

Also, the output unit 59 is a processing unit that writes the header file 73 generated by the generation unit 58 to the storage unit 53.

### (Flow of Processing)

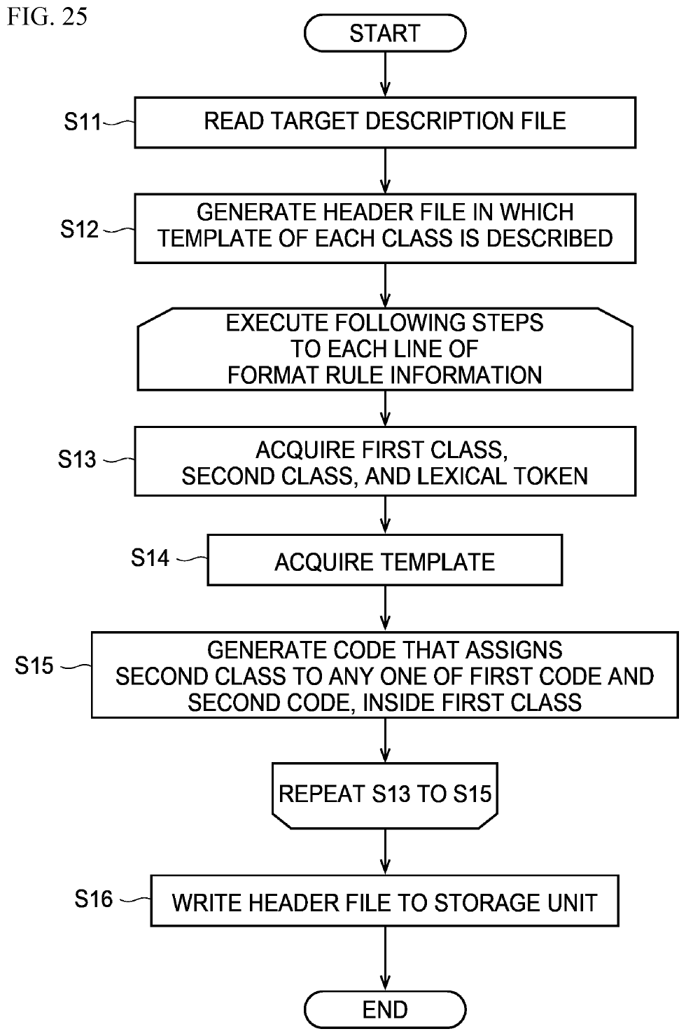

FIG. 25 is a flowchart illustrating a class generation method according to the present embodiment.

First, the file generation unit 54 reads the target description file 71 from the storage unit 53 (step S11), and generates the header file 73 from the target description file 71 (step S12). As described with reference to FIG. 17, in the header file 73, the definitions 73a and 73b of the classes 72a to 72i are generated by the file generation unit 54. Further, the file generation unit 54 also generates, in the header file 73, the process 73c (see FIG. 17) for generating the instance of the VReg class 72a.

Next, the first acquisition unit 56 acquires the first class, the second class, and the lexical token which are associated with each other by referring to the format rule information 75 (see FIG. 18) (step S13).

Subsequently, the second acquisition unit 57 acquires the template corresponding to the lexical token acquired in step S13 among the templates 76a and 76b by referring to the template information 76 (see FIG. 18) (step S14). For example, when the lexical token acquired in step S13 is the dot “.”, the second acquisition unit 57 acquires the first template 76a associated with the dot “.”. When the lexical token acquired in step S13 is either the square brackets “[ ]” or the hyphen “-”, the second acquisition unit 57 uses the second template 76b associated with these lexical tokens.

Next, the generation unit 58 generates a code that assigns the second class acquired in step S13 to any one of the first code and the second code, inside the first class of the header file 73 (step S15).

For example, consider the case where the first acquisition unit 56 acquires the first line of the format rule information 75 (see FIG. 18) in step S13. In that case, as illustrated in FIG. 19, the generation unit 58 generates a plurality of first codes 77 for generating the instance of the second class such as the VReg2D class inside the VReg class 72a.

On the other hand, consider the case where the first acquisition unit 56 acquires the second line of the format rule information 75 in step S13. In that case, as illustrated in FIGS. 19 to 20, the generation unit 58 generates the second code 78 including the member function “operator” that overloads the square brackets “[ ]” and the hyphen “-”, inside each class 72b to 72i.

Then, by performing steps S13 to S15 on all the lines included in the format rule information 75, the first code 77 and the second code 78 are generated inside all the first class included in the format rule information 75.

After that, the output unit 59 writes the header file 73 to the storage unit 53 (step S16).

### (Hardware Configuration)

Next, the hardware configuration of the information processing apparatus 50 according to the present embodiment will be described.

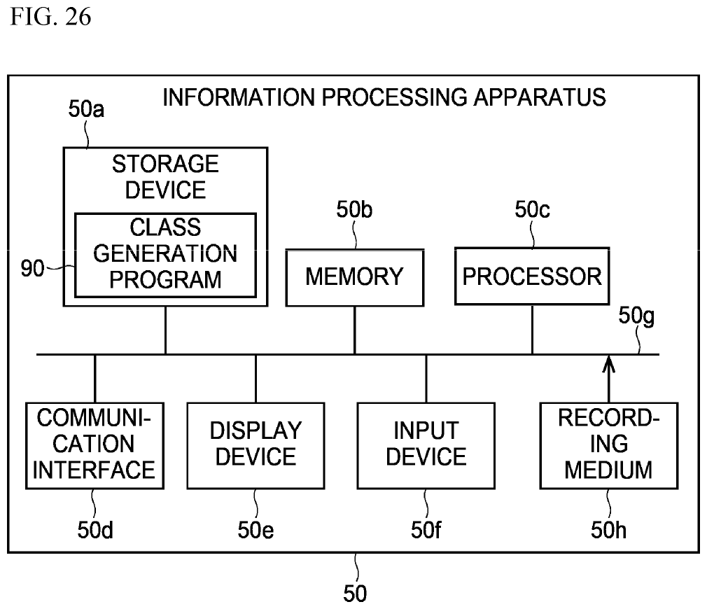

FIG. 26 is a hardware configuration diagram illustrating the information processing apparatus 50 according to the present embodiment.

As illustrated in FIG. 26, the information processing apparatus 50 includes a storage device 50a, a memory 50b, a processor 50c, a communication interface 50d, a display device 50e, and an input device 50f. These elements are connected to each other by a bus 50g.

The storage device 50a is a non-volatile storage such as an HDD or an SSD (Solid State Drive), and stores a class generation program 90 according to the present embodiment.

Here, the class generation program 90 may be recorded on a computer-readable recording medium 50h, and the processor 50c may read the class generation program 90 in the recording medium 50h.

Examples of such a recording medium 50h include physically portable recording media such as a CD-ROM (Compact Disc-Read Only Memory), a DVD (Digital Versatile Disc), and a USB (Universal Serial Bus) memory. Further, a semiconductor memory such as a flash memory, or a hard disk drive may be used as the recording medium 50h. The recording medium 50h is not a temporary medium such as a carrier wave having no physical form.

Further, the class generation program 90 may be stored in a device connected to a public line, an Internet, a LAN (Local Area Network), or the like, and the processor 50c may read and execute the class generation program 90.

Meanwhile, the memory 50b is hardware that temporarily stores data, such as a DRAM, and the class generation program 90 is deployed on the memory 50b.

The processor 50c is hardware such as a CPU or a GPU that controls each element of the information processing apparatus 50 and executes the class generation program 90 in cooperation with the memory 50b.

Thus, the processor 50c executes the class generation program 90 in cooperation with the memory 50b, so that the control unit 52 including the file generation unit 54, the first acquisition unit 56, the second acquisition unit 57, the generation unit 58, and the output unit 59 is realized. Further, the storage unit 53 is realized by the storage device 50a and the memory 50b.

Further, the communication interface 50d is an interface for connecting the information processing apparatus 50 to the network such as the LAN.

The display device 50e is hardware such as a liquid crystal display device, and displays a prompt prompting the developer to input various information. Also, the input device 50f is hardware such as a keyboard and a mouse. For example, the developer instructs the file generation unit 54 of the information processing apparatus 50 to generate the header file 73 from the target description file 71 by operating the input device 50f.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable recording medium storing a class generation program that causes a computer to execute a process, the process comprising:
acquiring a first class, a second class, and a lexical token which are associated with each other by referring to a storage unit that stores the first class, the second class, and the lexical token in association with each other, the first class representing a first format about a vector register, the second class representing a second format about the vector register and inheriting the first class; and
generating any one of a first code that generates an instance of the acquired second class and a second code that overloads the acquired lexical token, inside the acquired first class depending on the acquired lexical token.

2. The non-transitory computer-readable recording medium as claimed in claim 1, the process further comprising:
acquiring a template corresponding to the acquired lexeme among a first template and a second template by referring to the storage unit that stores the first template including the first code and the second template including the second code in association with to the lexeme;
wherein the generating any one of the first code and the second code is performed by generating a code that assigns the acquired second class to any one of the first code and the second code included in the acquired template.

3. The non-transitory computer-readable recording medium as claimed in claim 1, wherein
the first format is a format that specifies one of a plurality of vector registers, and
the second format is a format that identifies a number of elements included in the vector register and a size of an element.

4. The non-transitory computer-readable recording medium as claimed in claim 1, wherein
the first format is a format that identifies a number of elements included in the vector register and a size of an element, and
the second format is a format that specifies at least one of the element and a list of the vector register.

5. The non-transitory computer-readable recording medium as claimed in claim 1, wherein
the lexical token is any one of a dot, a square bracket, and a hyphen.

6. A class generation method that causes a computer to execute a process, the process comprising:
acquiring a first class, a second class, and a lexical token which are associated with each other by referring to a storage unit that stores the first class, the second class, and the lexical token in association with each other, the first class representing a first format about a vector register, the second class representing a second format about the vector register and inheriting the first class; and
generating any one of a first code that generates an instance of the acquired second class and a second code that overloads the acquired lexical token, inside the acquired first class depending on the acquired lexical token.
